(19) United States
(12) Patent Application Publication
(10) Pub. No.: US 2023/0014755 A1
(43) Pub. Date: Jan. 19, 2023

(54) LEARNING SYSTEM, LEARNING METHOD, APPROPRIATE INTEREST RATE PREDICTION SYSTEM, APPROPRIATE INTEREST RATE PREDICTION METHOD, RECORDING MEDIUM, AND LOAN MATING SYSTEM

(71) Applicant: NEC Corporation, Minato-ku, Tokyo (JP)

(72) Inventor: Yasuhiro AJIRO, Tokyo (JP)

(73) Assignee: NEC Corporation, Minato-ku, Tokyo (JP)

(21) Appl. No.: 17/781,784

(22) PCT Filed: Dec. 17, 2019
(86) PCT No.: PCT/JP2019/049353

§ 371 Date: Jun. 2, 2022

(51) Int. Cl. G06Q 40/02

(52) U.S. Cl. CPC G06Q 40/02

(57) ABSTRACT

A learning device includes a proposed interest rate acquisition means, a loan result acquisition means and a learning means. The proposed interest rate acquisition means acquires proposed interest rates of multiple lenders for a loan application. The loan result acquisition means acquires an interest rate at a time when a loan for the loan application is established. Then, the learning means learns an appropriate interest rate prediction model which uses the proposed interest rate as an explanatory variable and the interest rate at the time when the loan is established as an objective variable.

### TECHNICAL FIELD

The present invention relates to a technique for predicting an appropriate interest rate of loan in the market.

### BACKGROUND ART

A system has been proposed for matching the lending conditions of financial institutions and other lenders with the desired conditions of borrowers such as companies. For example, Patent Document 1 discloses an auction system in which a match-making is made between the desired borrowing condition of the borrower and the desired lending condition of the lender.

### PRECEDING TECHNICAL REFERENCES

### Patent Document

Patent Document 1: Japanese Patent Application Laid-Open under No. JP 2001-216403

### SUMMARY

### Problem to be Solved by the Invention

In the method of Patent Document 1, since the condition of the loan is determined based on the relationship between the desired lending condition of the lender and the desired borrowing condition of the borrower, it is not necessarily ensured that the loan is performed at an appropriate interest rate in the market at that time. Also, when the loan is performed between individuals, there are cases where the loan is not performed at an appropriate interest rate.

It is an object of the present invention to predict a more appropriate interest rate in the market at the time of performing loan.

### Means for Solving the Problem

According to an example aspect of the present invention, there is provided a learning system comprising:

a proposed interest rate acquisition means configured to acquire proposed interest rates of multiple lenders for a loan application;

a loan result acquisition means configured to acquire an interest rate at a time when a loan for the loan application is established; and

a learning means configured to learn an appropriate interest rate prediction model which uses the proposed interest rate as an explanatory variable and the interest rate at the time when the loan is established as an objective variable.

According another example aspect of the present invention, there is provided a learning method comprising:

acquiring proposed interest rates of multiple lenders for a loan application;

acquiring an interest rate at a time when a loan for the loan application is established; and

learning an appropriate interest rate prediction model which uses the proposed interest rate as an explanatory variable and the interest rate at the time when the loan is established as an objective variable.

According another example aspect of the present invention, there is provided a recording medium recording a program that causes a computer to execute:

acquiring proposed interest rates of multiple lenders for a loan application;

acquiring an interest rate at a time when a loan for the loan application is established; and

learning an appropriate interest rate prediction model which uses the proposed interest rate as an explanatory variable and the interest rate at the time when the loan is established as an objective variable.

According another example aspect of the present invention, there is provided an appropriate interest rate prediction system comprising:

a prediction means configured to predict an appropriate interest rate based on proposed interest rates proposed by multiple lenders using an appropriate interest rate prediction model, the appropriate interest rate prediction model being learned using the proposed interest rate as an explanatory variable and the interest rate at the time when the loan is established as an objective variable; and

an output means configured to output the appropriate interest rate predicted by the prediction means.

According another example aspect of the present invention, there is provided an appropriate interest rate prediction method comprising:

predicting an appropriate interest rate based on proposed interest rates proposed by multiple lenders using an appropriate interest rate prediction model, the appropriate interest rate prediction model being learned using the proposed interest rate as an explanatory variable and the interest rate at the time when the loan is established as an objective variable; and

outputting the appropriate interest rate predicted.

According another example aspect of the present invention, there is provided a recording medium recording a program that causes a computer to execute:

predicting an appropriate interest rate based on proposed interest rates proposed by multiple lenders using an appropriate interest rate prediction model, the appropriate interest rate prediction model being learned using the proposed interest rate as an explanatory variable and the interest rate at the time when the loan is established as an objective variable; and

outputting the appropriate interest rate predicted.

According another example aspect of the present invention, there is provided a loan matching system comprising:

a loan proposal acquisition means configured to acquire proposed interest rates proposed by multiple lenders;

an appropriate interest rate prediction means configured to predict an appropriate interest rate based on the proposed interest rates proposed by the multiple lenders using an appropriate interest rate prediction model, the appropriate interest rate prediction model being learned using the proposed interest rate as an explanatory variable and the interest rate at the time when the loan is established as an objective variable; and

an appropriate interest rate loan proposal generation means configured to output an appropriate interest rate loan proposal at the appropriate interest rate by the lender who has proposed the proposed interest rate closest to the appropriate interest rate.

### Effect of the Invention

According to the present invention, it becomes possible to predict a more appropriate interest rate in the market at the time of performing loan.

### BRIEF DESCRIPTION OF THE DRAWINGS

FIG. 1 illustrates a configuration and an operation of a loan matching system of a first example embodiment at the time of learning.

FIG. 2 illustrates a hardware configuration of a matching device.

FIG. 3 illustrates a hardware configuration of an appropriate interest rate prediction device.

FIG. 4 is a flowchart of learning processing by the appropriate interest rate prediction device.

FIG. 5 illustrates a configuration and an operation of the loan matching system of the first example embodiment at the time of prediction.

FIG. 6 is a flowchart of appropriate interest rate prediction processing.

FIG. 7 illustrates a configuration and an operation of a loan matching system of a second example embodiment.

FIG. 8 illustrates an operation of the loan matching system when co-financing is performed.

FIG. 9 illustrates a configuration and an operation of a loan matching system according to a third example embodiment.

FIGS. 10A and 10B illustrate configurations of a learning device and an appropriate interest rate prediction device according to a fourth example embodiment.

### EXAMPLE EMBODIMENTS

Preferred example embodiments of the present invention will be described with reference to the accompanying drawings.

### First Example Embodiment

Hereinafter, a loan matching system according to an example embodiment of the present invention will be described.

(Configuration at the Time of Learning)

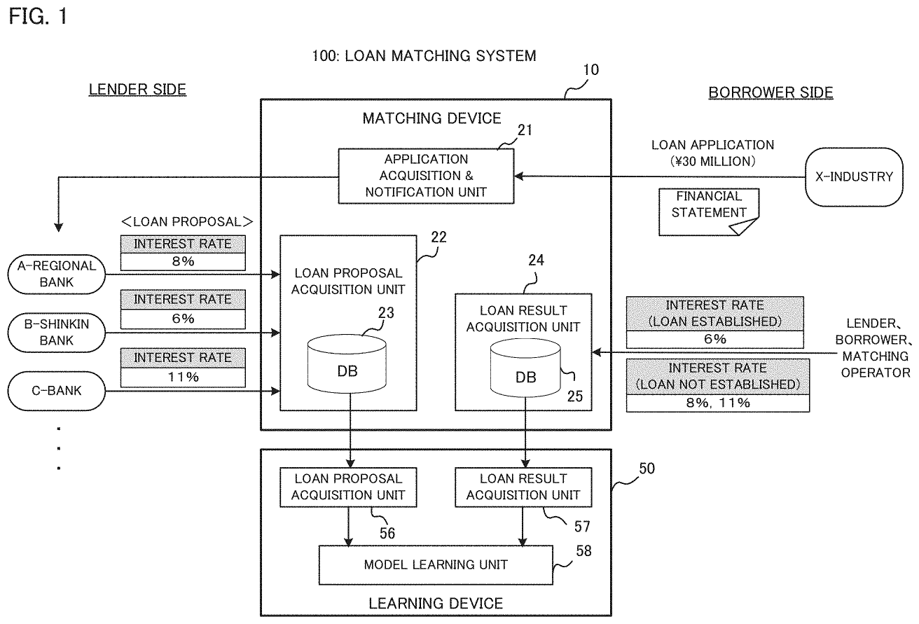

FIG. 1 shows the configuration and operation of the loan matching system 100 according to the first example embodiment at the time of learning. The loan matching system 100 is a system to perform matching of the loan between lenders such as financial institutions and borrowers such as companies. The loan matching system 100 includes a matching device 10 and a learning device 50. Note that the configuration at the time of learning is a configuration when the learning device 50 generates an appropriate interest rate prediction model used to predict an appropriate interest rate. Here, the “appropriate interest rate” is the interest rate when the demand and the supply match in the actual market and the loan is established. Therefore, the appropriate interest rate obtained here can be considered as the standard lending interest rate that does not depend on the special circumstances of the lender or borrower in the market at that time.

The matching device 10 acquires loan applications from the borrower side and loan proposals from the lender side, and matches the lender side with the borrower side. The matching device 10 includes an application acquisition and notification unit 21, a loan proposal acquisition unit 22, and a loan result acquisition unit 24.

Loan applications from the borrower side are inputted to the matching device 10. In the example of FIG. 1, the borrower is an enterprise called “X-industry” and wants a loan of 30 million yen. It should be noted that the X-Industry does not have any desired interest rate of loan. The X-Industry applies for loan by presenting documents such as financial statements, if necessary. Incidentally, the loan application may be made by transmission of data or the like, or may be made by manual input or the like to the matching device 10.

The application acquisition and notification unit 21 acquires the loan application from the borrower side and notifies the lender of the loan application. In the example of FIG. 1, the financial institutions of the lender side include the A-Regional Bank, the B-Shinkin Bank, and the C Bank.

Each financial institution on the lender side examines the loan application from the X-Industry, creates a loan proposal and provides it to the matching device 10. The loan proposal acquisition unit 22 acquires the loan proposal from each financial institution. Incidentally, the acquisition of the loan proposal may be made by transmission of data or the like, and may be made by manual input or the like to the matching device 10. The loan proposal includes at least the interest rate of lending (hereinafter referred to as the “proposed interest rate”). The loan proposal may also include an upper limit amount of loan. The loan proposal acquisition unit 22 stores the loan proposal acquired from each financial institution in the loan proposal database (“DB”) 23.

Subsequently, when the loan is established between one of the financial institutions on the lender side and the X-industry on the borrower side, the loan result is provided to the matching device 10. In the example of FIG. 1, it is assumed that the loan by the B-Shinkin Bank is established. In this case, as the loan result, at least the interest rate at which the loan is established is provided to the matching device 10. The loan results are usually provided by the borrower or the lender. However, the loan results may be provided by an operator of the loan matching system 100 intervening between the lender and the borrower. In addition, it is preferable that not only the interest rate with which the loan is established, but also the interest rate with which the loan is not established is provided as the loan result. In the example of FIG. 1, the interest rate “6%” at the time when the loan is established and the interest rates “8%, 11%” at the time when the loan is not established are provided to the matching device 10 as the loan results. The provision of the loan result may be performed by transmission of data or the like, or may be performed by manual input to the matching device 10 or the like. The loan result acquisition unit 24 of the matching device 10 stores the provided loan results in the loan result DB 25.

As described above, each time a loan transaction occurs, the loan proposal from each lender and final loan results are accumulated in the matching device 10. Then, learning by the learning device 50 is performed using the loan results. The learning device 50 learns an appropriate interest rate prediction model prepared in advance. The appropriate interest rate prediction model is a regression analysis model that uses the proposed interest rate included in the lender's loan proposal as an explanatory variable and the interest rate of the established loan included in the loan results as the objective variable. The appropriate interest rate prediction model may use a technique such as machine learning or deep learning, but is not limited to them.

The learning device 50 includes a loan proposal acquisition unit 56, a loan result acquisition unit 57, and a model learning unit 58. The loan proposal acquisition unit 56 acquires the loan proposals from the loan proposal DB 23 of the matching device 10. The loan result acquisition unit 57 acquires the loan results from the loan result DB 25. The model learning unit 58 learns an appropriate interest rate prediction model using the loan proposals acquired by the loan proposal acquisition unit 56 and the loan results acquired by the loan result acquisition unit 57. The model learning unit 58 may learn not only the interest rate at the time when the loan is established, which is included in the loan result, but also the interest rate at the time when the loan is not established. The accuracy of predicting the appropriate interest rate can be improved by learning the interest rate at the time when the loan is not established in addition to the interest rate at the time when the loan is established. In this way, by the learning using the proposed interest rates acquired for many loan cases and the interest rates at the time when the loan is established, it becomes possible to learn an appropriate interest rate prediction model that can predict the appropriate interest rate with high accuracy.

(Hardware Configuration)

Next, hardware configurations of the matching device 10 and the learning device 50 will be described.

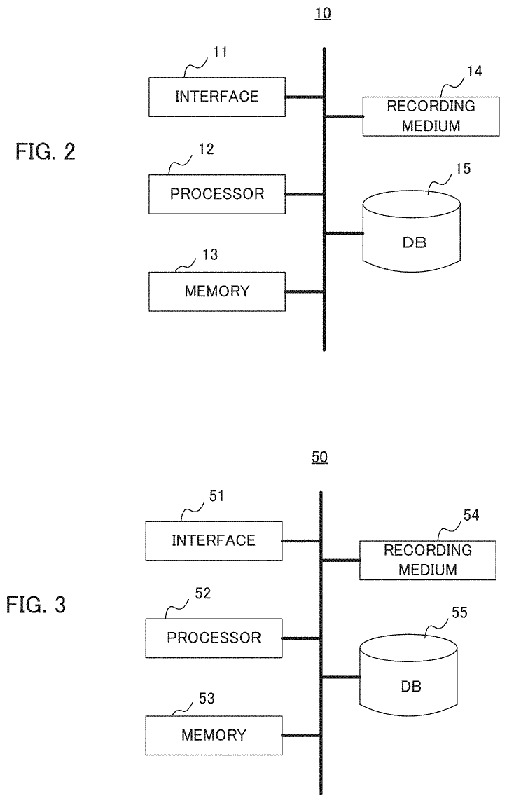

FIG. 2 is a block diagram showing a hardware configuration of the matching device 10. The matching device 10 includes an interface 11, a processor 12, a memory 13, a recording medium 14, and a database (DB) 15.

The interface 11 performs input and output of data to and from an external device. Specifically, the interface 11 acquires data provided by the lender side and the borrower side, and outputs the loan proposals and the loan results to a learning device 50. The processor 12 is a computer such as a CPU (Central Processing Unit) and controls the entire matching device 10 by executing a program prepared in advance. The memory 13 is configured by a ROM (Read Only Memory), RAM (Random Access Memory), or the like. The memory 13 stores various programs to be executed by the processor 12. The memory 13 is also used as a work memory during the execution of various processes by the processor 12.

The recording medium 14 is a non-volatile and non-transitory recording medium such as a disk-shaped recording medium, a semiconductor memory, and is configured to be detachable from the matching device 10. The recording medium 14 records various programs to be executed by the processor 12. When the matching device 10 performs processing, a program recorded on the recording medium 14 is loaded into the memory 13 and executed by the processor 12.

The database 15 stores data that is inputted through the interface 11. Specifically, the database 15 functions as the above-described loan proposal DB 23 and the loan result DB 25. In addition to the above, the matching device 10 may include an input device used when the lender, the borrow, the operator or the like inputs information, and a display unit.

FIG. 3 is a block diagram showing a hardware configuration of the learning device 50. The learning device 50 includes an interface 51, a processor 52, a memory 53, a recording medium 54, and a database (DB) 55.

The interface 51 performs input and output of data from and to an external device. Specifically, the interface 51 acquires the loan proposals and the loan results from the matching device 10. The processor 52 is a computer such as a CPU, or a CPU with a GPU (Graphics Processing Unit), and controls the entire learning device 50 by executing a program prepared in advance. The memory 53 is composed of a ROM, a RAM, and the like. The memory 53 stores various programs to be executed by the processor 52. The memory 53 is also used as a work memory during the execution of various processes by the processor 52.

The recording medium 54 is a non-volatile and non-transitory recording medium such as a disk-shaped recording medium, a semiconductor memory, or the like, and is configured to be detachable from the learning device 50. The recording medium 54 records various programs to be executed by the processor 52. When the learning device 50 executes the learning processing described later, a program recorded on the recording medium 54 is loaded into the memory 53 and executed by the processor 52.

The database 55 stores data that is inputted through the interface 51. Specifically, the database 55 stores the loan proposals and the loan results outputted from the matching device 10 so as to use them in the learning processing. In addition to the above, the learning device 50 may include an input device used when the user performs instructions or inputs, and a display unit.

(Learning Processing)

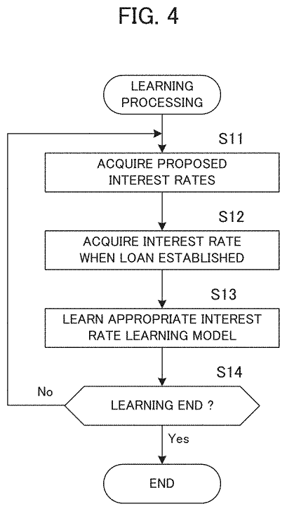

FIG. 4 is a flowchart of learning processing by the learning device 50. This processing is realized by the processor 52 shown in FIG. 3 which executes a program prepared in advance and operates as a model learning unit 58.

First, the loan proposal acquisition unit 56 acquires the proposed interest rates included in the loan proposals outputted from the matching device 10 (Step S11). In addition, the loan result acquisition unit 57 acquires the interest rates at the time when the loan is established, which are included in the loan results outputted from the matching device 10 (step S12). Then, the model learning unit 58 learns the appropriate interest rate prediction model using the proposed interest rates and the interest rates at the time when the loan is established (Step S13). The model learning unit 58 repeats the learning until a predetermined ending condition is satisfied, and ends the learning when the ending condition is satisfied. Incidentally, the ending condition may be that a predetermined number of data prepared is used, that the variation width of the objective variable has converged within a predetermined value, and the like.

(Configuration at the Time of Prediction)

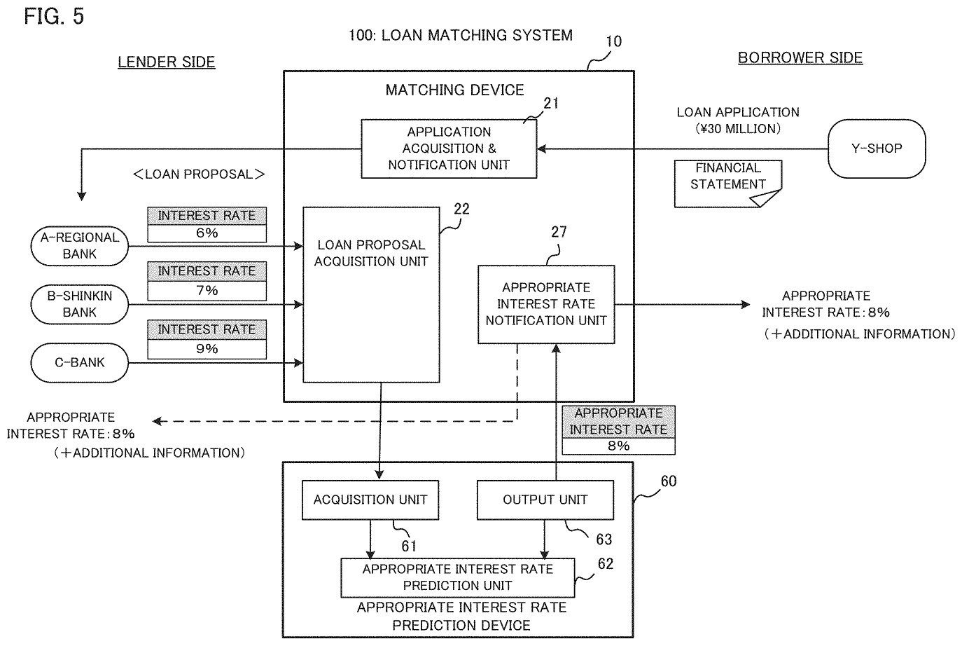

Next, the configuration of the loan matching system 100 at the time of prediction will be described. FIG. 5 shows the configuration and operation of the loan matching system 100 at the time of prediction. The configuration at the time of prediction is the configuration when the appropriate interest rate is predicted using the learned appropriate interest rate prediction model. The loan matching system 100 includes the matching device 10 and an appropriate interest rate prediction device 60.

The appropriate interest rate prediction device 60 includes an acquisition unit 61, an appropriate interest rate prediction unit 62, and an output unit 63. The acquisition unit 61 acquires the loan proposals from the loan proposal acquisition unit 22. The appropriate interest rate prediction unit 62 predicts the appropriate interest rate using the appropriate interest rate prediction model learned in the learning processing described above. The output unit 63 outputs the appropriate interest rate predicted by the appropriate interest rate prediction unit 62 to the matching device 10. Incidentally, the hardware configuration of the appropriate interest rate prediction device 60 is the same as the hardware configuration of the learning device 50 shown in FIG. 3.

The matching device 10 includes the application acquisition and notification unit 21, the loan proposal acquisition unit 22, and an appropriate interest rate notification unit 27. The application acquisition and notification unit 21 acquires a loan application from the borrower side and notifies the lender of the loan application. The loan proposal acquisition unit 22 outputs the loan proposal acquired from each financial institution to the appropriate interest rate prediction device 60. The appropriate interest rate notification unit 27 notifies the borrower of the appropriate interest rate outputted by the appropriate interest rate prediction device 60. Specifically, for example, the appropriate interest rate notification unit 27 may output the appropriate interest rate received from the appropriate interest rate prediction device 60 to the terminal device operated on the borrower side. Further, for example, the appropriate interest rate notification unit 27 may control the terminal device operated on the borrower side so as to display the appropriate interest rate received from the appropriate interest rate prediction device 60 on the display screen of the terminal device.

Next, the operation of the loan matching system 100 at the time of prediction will be described. It is now supposed that, as shown in FIG. 5, Y-shop on the borrower side made a loan application of 30 million yen. The application acquisition and notification unit 21 of the matching device 10 notifies plural financial institutions on the lender side of this loan application. Each financial institution conducts an examination and provides a loan proposal to the matching device 10. The loan proposal acquisition unit 22 of the matching device 10 outputs the loan proposal of each financial institution to the appropriate interest rate prediction device 60.

The acquisition unit 61 acquires the loan proposal from each financial institution. The appropriate interest rate prediction unit 62 uses the learned appropriate interest rate prediction model to predict the appropriate interest rate from those proposed interest rates. The output unit 63 outputs the appropriate interest rate predicted by the appropriate interest rate prediction unit 62 to the matching device 10. In this example, the appropriate interest rate is predicted to be “8%” and is outputted to the matching device 10. The appropriate interest rate notification unit 27 of the matching device 10 outputs the appropriate interest rate outputted by the output unit 63 to the borrower side. In this way, the loan matching system 100 presents the appropriate interest rate considered appropriate under the market conditions at that time for the loan application of Y-Shop. Then, Y-shop may negotiate with each financial institution in consideration of the information on the appropriate interest rate.

In addition to the appropriate interest rate, the appropriate interest rate notification unit 27 may provide additional information to the borrower. For example, the appropriate interest rate notification unit 27 may provide, as additional information, a statistic based on a loan proposal of each financial institution. Specifically, the appropriate interest rate notification unit 27 may provide the maximum, minimum, and average of the proposed interest rates of each financial institution. Also, the appropriate interest rate notification unit 27 may provide information on whether the appropriate interest rate is higher or lower than the average of each financial institution's proposed interest rate.

Further, the appropriate interest rate notification unit 27 may output the appropriate interest rate predicted by the appropriate interest rate prediction device 60 to each of the terminal device used in each financial institution. Further, the appropriate interest rate notification unit 27 may output additional information to each terminal device used in each financial institution. For example, the appropriate interest rate notification unit 27 may output, as additional information, information such as how many financial institutions has proposed an interest rate lower than the appropriate interest rate (i.e., financial institutions that view the borrower's risk at a low level), to each terminal device used by each financial institution.

(Appropriate Interest Rate Prediction Processing)

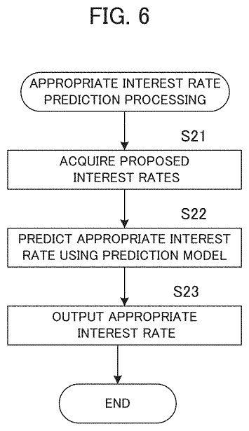

FIG. 6 is a flowchart of the appropriate interest rate prediction processing performed by the appropriate interest rate prediction device 60. This processing is realized by the processor 52 shown in FIG. 3, which executes a program prepared in advance and operates as the appropriate interest rate prediction unit 62.

First, the acquisition unit 61 acquires the proposed interest rates included in the loan proposals inputted from the matching device 10 (step S21). Next, the appropriate interest rate prediction unit 62 predicts the appropriate interest rate from the proposed interest rates using the learned appropriate interest rate prediction model (Step S22). Then, the output unit 63 outputs the predicted appropriate interest rate to the matching device 10 (step S23).

As described above, according to the loan matching system 100 of the first example embodiment, an appropriate interest rate prediction model can be learned based on data of a large number of actual loan cases, and the appropriate interest rate can be predicted using that model. By notifying the borrower and/or lender of the predicted appropriate interest rate as reference information, it can be expected to increase the opportunity for the loan to be established at a rate close to the appropriate interest rate. That is, it becomes possible to reduce the cases that lenders make loans at unfairly low interest rates in view of the market or borrowers receive loans at unfairly high interest rates, thereby facilitating loans.

(Modification)

In the above example embodiment, the proposed interest rate is used as an explanatory variable for the appropriate interest rate prediction model. In addition to this, the maximum amount of the loan (the credit line) may be used. Further, as information on loan applications from the borrower side, the reason for applying for the loan (the use of the loan), the type of borrower company, and information related to the borrower's financial statements (such as sales, profits, profit margins, and profit growth rates) may be used. Thus, it becomes possible to improve the prediction accuracy of the appropriate interest rate.

Although the above information are related to the individual loan applications, information on the lender side may be used as explanatory variables in addition to the information on the above-mentioned loan applications. For example, information on the lender side includes information on the lender's lending situation of each financial institution, and information on the amount of loans and financing trends in Japan as a whole. Thus, the prediction accuracy of the appropriate interest rate can be improved by using information that affects the actual interest rate in the market as an explanatory variable.

### Second Example Embodiment

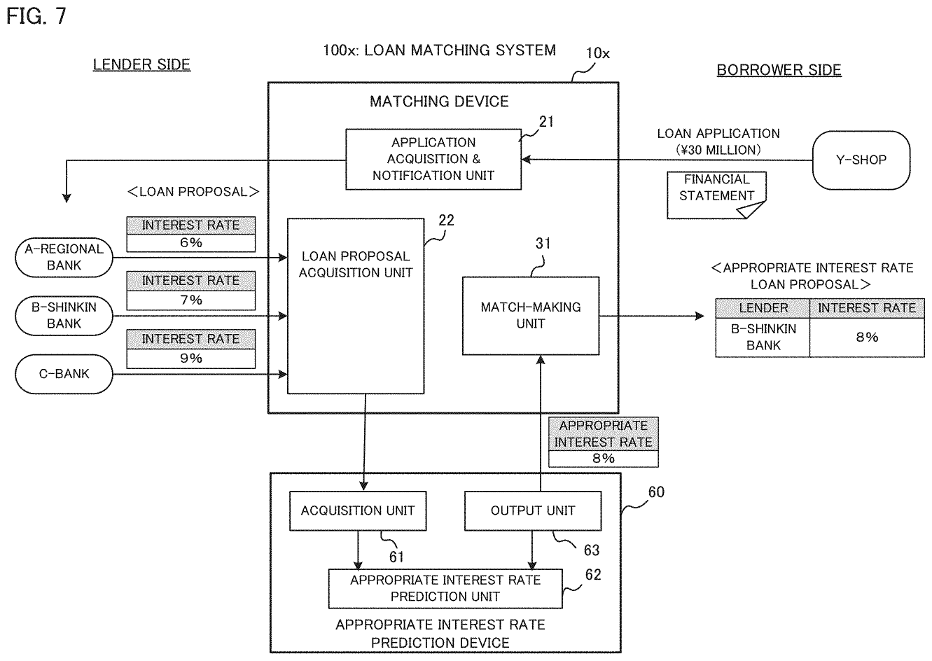

Next, a second example embodiment of the present invention will be described. While the loan matching system 100 of the first example embodiment predicts an appropriate interest rate for a loan, the loan matching system 100x of the second example embodiment performs matching between a lender and a borrower. FIG. 7 shows the configuration and operation of the loan matching system 100x according to the second example embodiment. The loan matching system 100x includes a matching device 10x and the appropriate interest rate prediction device 60. The matching device 10x includes the application acquisition and notification unit 21, the loan proposal acquisition unit 22, and a match-making unit 31. Incidentally, the appropriate interest rate prediction device 60 is the same as that of the first example embodiment.

Next, the operation of the loan matching system 100x of the second example embodiment will be described with reference to FIG. 7. The operation until the appropriate interest rate prediction device 60 predicts the appropriate interest rate for the loan application from the borrower is the same as in the first example embodiment. That is, in the example shown in FIG. 7, a loan application from Y-shop, which is the borrow, is notified to a plurality of financial institutions on the lender side through the matching device 10x, and a loan proposal of each financial institution is outputted to the matching device 10x. The loan proposal acquisition unit 22 outputs the loan proposal of each financial institution to the appropriate interest rate prediction device 60. The appropriate interest rate prediction device 60 uses the appropriate interest rate prediction model to predict the appropriate interest rate based on the loan proposal of each financial institution and outputs the appropriate interest rate to the matching device 10x.

The match-making unit 31 of the matching device 10x chooses the optimum loan proposal from the loan proposals from plural lenders based on the appropriate interest rate and presents the optimum loan proposal to the borrower. Here, the match-making unit 31 generates a loan proposal at the appropriate interest rate predicted by the appropriate interest rate prediction device 60 regardless of the proposed interest rate of each financial institution which is the lender. A loan proposal at the appropriate interest rate is hereinafter referred to as “an appropriate interest rate loan proposal.” The match-making unit 31 chooses the lender, from the plurality of lenders, who have proposed the interest rate that is lower than and closest to the appropriate interest rate. In the example of FIG. 7, the appropriate interest rate prediction device 60 predicts the appropriate interest rate as “8%.” Therefore, the match-making unit 31 chooses the B-Shinkin Bank which proposes an interest rate of “7%” that is lower than and closest to the appropriate interest rate, as the lender, from the three financial institutions. Then, the match-making unit 31 presents the borrower with an appropriate interest rate loan proposal for which the lender is the B-Shinkin Bank and the interest rate is 8%. In other words, the match-making unit 31 generates an appropriate interest rate loan proposal for which the lender is the B-Shinkin Bank and the interest rate is 8%, and outputs the generated appropriate loan proposal to the terminal device operated by the borrower.

The reason why the match-making unit 31 chooses the lender who has proposed an interest rate lower than and closest to the appropriate interest rate is as follows. If the lender is chosen in the order from the lower proposed interest rate, the lender who proposes the lower rate will be able to lend. Here, in this loan matching system 100x, since the actual loan is made at the appropriate interest rate, even if the lender presents a low interest rate, the loan is not actually made at that interest rate. Thus, all lenders will propose a low rate for the purpose of making it easier to be chosen by the match-making unit 31, so that a mechanism to predict the appropriate rate based on the proposed interest rates from the lenders will not work. Therefore, the match-making unit 31 chooses the lender who proposes an interest rate lower than and closest to the appropriate interest rate. This brings the lender's proposed interest rate closer to the appropriate interest rate, and the mechanism to predict the appropriate interest rate works correctly. Incidentally, the match-making unit 31 is an example of an appropriate interest rate loan proposal generating unit of the present invention.

Next, a description will be given of an example in which co-financing is performed in the loan matching system 100x of the second example embodiment. Co-financing refers to the financing by multiple lenders in response to a loan application from a borrower. Specifically, when a single lender's upper-limit loan amount is lower than the desired loan amount of the borrower, the borrower's desired amount is lent by the combination of loans from multiple lenders.

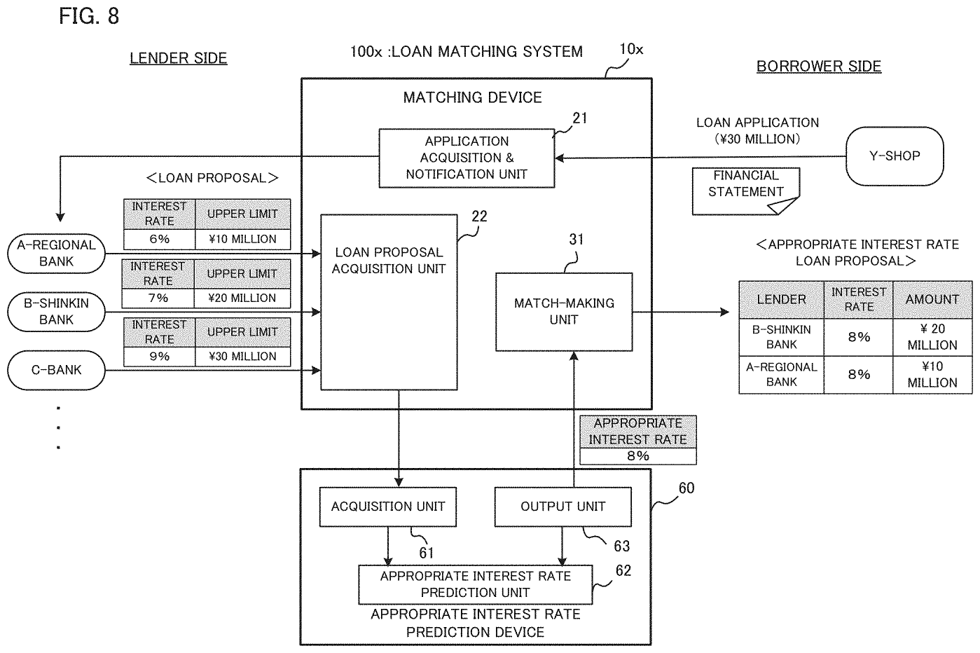

FIG. 8 shows the operation of the loan matching system 100x when co-financing is performed. In this example, the desired loan amount of the Y-Shop, who is a borrower, is 30 million yen. As mentioned above, since the match-making unit 31 chooses the lender who offers an interest rate lower than and closest to the appropriate interest rate, the match-making unit 31 first chooses the B-Shinkin Bank as the lender. However, the upper-limit loan amount by the B-Shinkin Bank is 20 million yen, which is 10 million yen short of the borrower's desired loan amount of 30 million yen. Therefore, the match-making unit 31 chooses the A-Regional Bank, which proposes an interest rate lower than the appropriate interest rate and second closest to the appropriate interest rate, as a second lender. The match-making unit 31 then makes a co-financing proposal of 20 million yen from the B-Shinkin Bank and 10 million yen from the A-Regional Bank to the lender. That is, the match-making unit 31 generates the appropriate interest rate loan proposal shown in FIG. 8 and outputs the generated loan proposal to the terminal device operated by the borrower. It is noted that, even in this case, the interest rate of the loan is set to the appropriate interest rate. This allows a borrower to realize the desired loan amount by the co-financing from multiple lenders even if the upper-limit loan amount from one lender is lower than the borrower's desired loan amount.

### Third Example Embodiment

Next, a third example embodiment of the present invention will be described. In the first and second example embodiments described above, the appropriate interest rate is predicted based on the interest rates actually proposed by the lenders. In contrast, in the third example embodiment, the proposed interest rates from the lenders are predicted on the system side, and an appropriate interest rate is predicted based on them.

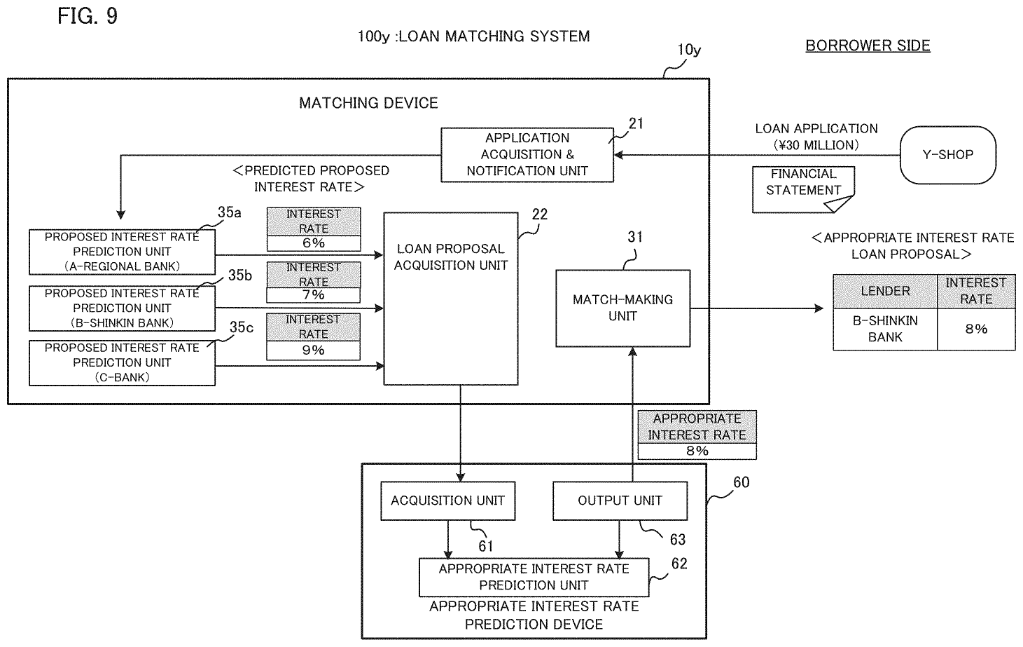

FIG. 9 shows a configuration and an operation of the loan matching system 100y according to the third example embodiment. The loan matching system 100y of the third example embodiment includes a matching device 10y and the appropriate interest rate prediction device 60. The matching device 10y includes the application acquisition and notification unit 21, the loan proposal acquisition unit 22, the match-making unit 31, and proposed interest rate prediction units 35a to 35c. The proposed interest rate prediction units 35a to 35c are predictors that have been learned in advance based on data (information on loan applications, loan proposals, etc.) in a large number of past loan cases, and can be constructed using machine learning and a neutral network. Specifically, the proposed interest rate prediction unit 35a is learned based on data on past loan cases by the A-Regional Bank, and outputs the proposed interest rate according to the trend of the loan by the A-Regional Bank when the information of the loan application is inputted. Similarly, the proposed interest rate prediction unit 35b outputs the proposed interest rate according to the trend of the loan by the B-Shinkin Bank, and the proposed interest rate prediction unit 35c outputs the proposed interest rate according to the trend of the loan by the C Bank. In this configuration, if the proposed interest rate prediction unit of each lender is regarded as a weak learner, the whole becomes an ensemble learner. Therefore, the improvement of the prediction accuracy of the appropriate interest rate can be expected. In addition, by using the proposed interest rate prediction unit 35a to 35c, the operational burden of each financial institution for the loan can be reduced.

Except for the above points, the operation of the loan matching system 100y according to the third example embodiment is the same as that of the loan matching system 100x of the second example embodiment. That is, the appropriate interest rate prediction device 60 predicts an appropriate interest rate based on the predicted proposed interest rate of each financial institution acquired from the loan proposal acquisition unit 22, and outputs the appropriate interest rate to the match-making unit 31. The match-making unit 31 chooses the lender who proposes an interest rate lower than and closest to the appropriate interest rate, and makes the appropriate interest rate loan proposal to the lender. If the maximum amount of loan from an individual lender is lower than the borrower's desired loan amount, the co-financing may be performed as described above. That is, in that case, the match-making unit 31 notifies the borrower of the necessity of co-financing and the noticeable candidates of the lenders for the co-financing.

Thus, according to the third example embodiment, it is possible to predict the lender's loan proposals and make a loan proposal at an appropriate interest rate. Actually, the loan matching system 100y requests the relevant lenders to confirm the content of the determined loan proposal at the appropriate interest rate, and then makes a proposal to the borrower.

In the above example, the proposed interest rate prediction units 35a to 35c are configured by a predictor using machine learning, single regression analysis, and multiple regression analysis. Instead, the proposed interest rate prediction units 35a to 35c may be configured by a rule-based predictor that calculates the predicted proposal interest rate according to a predetermined rule. For example, each proposed interest rate prediction unit 35 may calculate the predicted proposed interest rate based on the lending rules of the financial institution (a combination of conditions concerning the attributes of the borrower). Also, it may be different for each financial institution whether to use a predictor that uses machine learning, a predictor that uses a single regression analysis, a predictor that uses multiple regression analysis, or a rule-based predictor.

### Fourth Example Embodiment

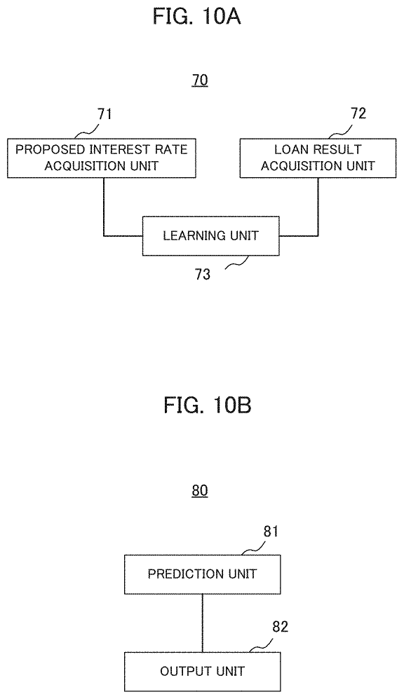

Next, a fourth example embodiment of the present invention will be described. FIG. 10A is a block diagram illustrating a functional configuration of a learning device according to a fourth example embodiment. The learning device 70 includes a proposed interest rate acquisition unit 71, a loan result acquisition unit 72, and a learning unit 73. The proposed interest rate acquisition unit 71 acquires proposed interest rates of multiple lenders for a loan application. The loan result acquisition unit 72 acquires an interest rate at the time when the loan for the loan application is established. Then, the learning unit 73 learns an appropriate interest rate prediction model which uses the proposed interest rate as an explanatory variable and the interest rate at the time when the loan is established as an objective variable.

FIG. 10B is a block diagram illustrating a functional configuration of an appropriate interest rate prediction device according to a fourth example embodiment. The appropriate interest rate prediction system 80 includes a prediction unit 81 and an output unit 82. The prediction unit 81 predicts an appropriate interest rate based on proposed interest rates proposed by multiple lenders using an appropriate interest rate prediction model. The appropriate interest rate prediction model is learned using the proposed interest rate as an explanatory variable and the interest rate at the time when the loan is established as an objective variable. The output unit 82 outputs the appropriate interest rate predicted by the prediction unit 81.

[Modification]

In the above example embodiments, the match-making unit 31 chooses the lender who proposes an interest rate lower than and closest to the appropriate interest rate for the appropriate interest rate loan proposal. Instead, the match-making unit 31 may choose the lender who proposes the interest rate closest to the appropriate interest rate for the appropriate interest rate loan proposal. In this case, when performing a co-financing, the match-making unit 31 can choose multiple lenders in the order from the lenders who propose an interest rate close to the appropriate interest rate.

A part or all of the processing and the operations performed in the loan matching system according to the present invention described above may be performed in a cloud computing. By distributing functions by cloud computing, the processing load of each device can be reduced.

Some or all of the example embodiments described above may also be described as the following appendices, but not limited thereto.

(Supplementary Note 1)

A learning system comprising:

a proposed interest rate acquisition means configured to acquire proposed interest rates of multiple lenders for a loan application;

a loan result acquisition means configured to acquire an interest rate at a time when a loan for the loan application is established; and

a learning means configured to learn an appropriate interest rate prediction model which uses the proposed interest rate as an explanatory variable and the interest rate at the time when the loan is established as an objective variable.

(Supplementary Note 2)

The learning system according to Supplementary note 1,

wherein the loan result acquisition means acquires the interest rate when the loan is not established, and

wherein the learning means learns the appropriate interest rate prediction model using the interest rate when the loan is not established.

(Supplementary Note 3)

The learning system according to Supplementary note 1 or 2,

wherein the loan application includes a loan amount, and

wherein the learning means learns the appropriate interest rate prediction model using the loan amount as an explanatory variable.

(Supplementary Note 4)

The learning system according to any one of Supplementary notes 1 to 3, wherein the learning means learns the appropriate interest rate prediction model using at least one of a reason for the loan application, financial statement information of a borrower who has made the loan application, and an industry type of the borrower as an explanatory variable.

(Supplementary Note 5)

The learning system according to any one of Supplementary notes 1 to 4, further comprising a lender information acquisition means configured to acquire information indicating a lending situation of each of the lenders,

wherein the learning means learns the appropriate interest rate prediction model using information indicating the lending situation as an explanatory variable.

(Supplementary Note 6)

A learning method comprising:

acquiring proposed interest rates of multiple lenders for a loan application;

acquiring an interest rate at a time when a loan for the loan application is established; and

learning an appropriate interest rate prediction model which uses the proposed interest rate as an explanatory variable and the interest rate at the time when the loan is established as an objective variable.

(Supplementary Note 7)

A recording medium recording a program that causes a computer to execute:

acquiring proposed interest rates of multiple lenders for a loan application;

acquiring an interest rate at a time when a loan for the loan application is established; and

learning an appropriate interest rate prediction model which uses the proposed interest rate as an explanatory variable and the interest rate at the time when the loan is established as an objective variable.

(Supplementary Note 8)

An appropriate interest rate prediction system comprising:

a prediction means configured to predict an appropriate interest rate based on proposed interest rates proposed by multiple lenders using an appropriate interest rate prediction model, the appropriate interest rate prediction model being learned using the proposed interest rate as an explanatory variable and the interest rate at the time when the loan is established as an objective variable; and

an output means configured to output the appropriate interest rate predicted by the prediction means.

(Supplementary Note 9)

The appropriate interest rate prediction system according to Supplementary note 8, wherein the output means further outputs the proposed interest rates of the multiple lenders, and a statistic relating to a magnitude relationship between the proposed interest rates of the multiple lenders and the appropriate interest rate.

(Supplementary Note 10)

An appropriate interest rate prediction method comprising:

predicting an appropriate interest rate based on proposed interest rates proposed by multiple lenders using an appropriate interest rate prediction model, the appropriate interest rate prediction model being learned using the proposed interest rate as an explanatory variable and the interest rate at the time when the loan is established as an objective variable; and

outputting the appropriate interest rate predicted.

(Supplementary Note 11)

A recording medium recording a program that causes a computer to execute:

predicting an appropriate interest rate based on proposed interest rates proposed by multiple lenders using an appropriate interest rate prediction model, the appropriate interest rate prediction model being learned using the proposed interest rate as an explanatory variable and the interest rate at the time when the loan is established as an objective variable; and

outputting the appropriate interest rate predicted.

(Supplementary Note 12)

A loan matching system comprising:

a loan proposal acquisition means configured to acquire proposed interest rates proposed by multiple lenders;

an appropriate interest rate prediction means configured to predict an appropriate interest rate based on the proposed interest rates proposed by the multiple lenders using an appropriate interest rate prediction model, the appropriate interest rate prediction model being learned using the proposed interest rate as an explanatory variable and the interest rate at the time when the loan is established as an objective variable; and

an appropriate interest rate loan proposal generation means configured to output an appropriate interest rate loan proposal at the appropriate interest rate by the lender who has proposed the proposed interest rate closest to the appropriate interest rate.

(Supplementary Note 13)

The loan matching system according to Supplementary note 12, wherein the appropriate interest rate loan proposal generation means generates the appropriate interest rate loan proposal by the lenders who have proposed the proposed interest rate close to the appropriate interest rate, when a loan amount of the loan application is larger than a proposed loan amount by the lender who has proposed the proposed interest rate closest to the appropriate interest rate.

(Supplementary Note 14)

The loan matching system according to Supplementary note 12 or 13, further comprising a proposed interest rate prediction means configured to predict the proposed interest rate for each of the multiple lenders,

wherein the appropriate interest rate prediction means predicts the appropriate interest rate using the proposed interest rates predicted by the proposed interest rate prediction means.

While the present invention has been described with reference to the example embodiments and the examples, the present invention is not limited to the example embodiments and the examples described above. Various changes that can be understood by those skilled in the art within the scope of the present invention can be made in the configuration and details of the present invention.

### INDUSTRIAL APPLICABILITY

While the lender is a financial institution in the above description of the present invention, the lender is not limited to the financial institution. For example, the present invention is also applicable to the case of lending between individuals or in the case of lending from multiple individuals to one individual. The present invention is also applicable to social lending and financing-type crowdfunding.

### DESCRIPTION OF SYMBOLS

100, 100x, and 100y Loan matching systems
10, 10x, 10y Matching device
21 Application acquisition and notification unit
22 Loan proposal acquisition unit
24 Loan result acquisition unit
27 Appropriate interest rate notification unit
31 Match-making unit
50 Learning device
56 Loan proposal acquisition unit
57 Model learning unit
58 Loan result acquisition unit
60 Appropriate interest rate prediction device
61 Acquisition unit
62 Appropriate interest rate prediction unit
63 Output unit

What is claimed is:

1. A learning system comprising:
a memory configured to store instructions; and
one or more processors configured to execute the instructions to:
acquire proposed interest rates of multiple lenders for a loan application;
acquire an interest rate at a time when a loan for the loan application is established; and
learn an appropriate interest rate prediction model which uses the proposed interest rate as an explanatory variable and the interest rate at the time when the loan is established as an objective variable.

2. The learning system according to claim 1,
wherein the one or more processors are configured to acquire the interest rate when the loan is not established, and
wherein the one or more processors are configured to learn the appropriate interest rate prediction model using the interest rate when the loan is not established.

3. The learning system according to claim 1,
wherein the loan application includes a loan amount, and
wherein the one or more processors are configured to learn the appropriate interest rate prediction model using the loan amount as an explanatory variable.

4. The learning system according to claim 1, wherein the one or more processors are configured to learn the appropriate interest rate prediction model using at least one of a reason for the loan application, financial statement information of a borrower who has made the loan application, and an industry type of the borrower as an explanatory variable.

5. The learning system according to claim 1,
wherein the one or more processors are configured to acquire information indicating a lending situation of each of the lenders, and
wherein the one or more processors are configured to learn the appropriate interest rate prediction model using information indicating the lending situation as an explanatory variable.

6. A learning method comprising:
acquiring proposed interest rates of multiple lenders for a loan application;
acquiring an interest rate at a time when a loan for the loan application is established; and
learning an appropriate interest rate prediction model which uses the proposed interest rate as an explanatory variable and the interest rate at the time when the loan is established as an objective variable.

7. A non-transitory computer-readable recording medium recording a program that causes a computer to execute:
acquiring proposed interest rates of multiple lenders for a loan application;
acquiring an interest rate at a time when a loan for the loan application is established; and
learning an appropriate interest rate prediction model which uses the proposed interest rate as an explanatory variable and the interest rate at the time when the loan is established as an objective variable.

8. An appropriate interest rate prediction system comprising:
a memory configured to store instructions; and
one or more processors configured to execute the instructions to:
predict an appropriate interest rate based on proposed interest rates proposed by multiple lenders using an appropriate interest rate prediction model, the appropriate interest rate prediction model being learned by the learning method according to claim 6; and
output the appropriate interest rate predicted.

9. The appropriate interest rate prediction system according to claim 8, wherein the one of more processors are configured to output the proposed interest rates of the multiple lenders, and a statistic relating to a magnitude relationship between the proposed interest rates of the multiple lenders and the appropriate interest rate.

10. An appropriate interest rate prediction method comprising:
predicting an appropriate interest rate based on proposed interest rates proposed by multiple lenders using an appropriate interest rate prediction model, the appropriate interest rate prediction model being learned by the learning method according to claim 6; and
outputting the appropriate interest rate predicted.

11. A non-transitory computer-readable recording medium recording a program that causes a computer to execute:
predicting an appropriate interest rate based on proposed interest rates proposed by multiple lenders using an appropriate interest rate prediction model, the appropriate interest rate prediction model being learned by the learning method according to claim 6; and
outputting the appropriate interest rate predicted.

12. A loan matching system comprising:
a memory configured to store instructions; and
one or more processors configured to execute the instructions to:
acquire proposed interest rates proposed by multiple lenders;
predict an appropriate interest rate based on the proposed interest rates proposed by the multiple lenders using an appropriate interest rate prediction model, the appropriate interest rate prediction model being learned by the learning method according to claim 6; and
output an appropriate interest rate loan proposal at the appropriate interest rate by the lender who has proposed the proposed interest rate closest to the appropriate interest rate.

13. The loan matching system according to claim 12, wherein the one of more processors are configured to generate the appropriate interest rate loan proposal by the lenders who have proposed the proposed interest rate close to the appropriate interest rate, when a loan amount of the loan application is larger than a proposed loan amount by the lender who has proposed the proposed interest rate closest to the appropriate interest rate.

14. The loan matching system according to claim 12, the one of more processors are further configured to predict the proposed interest rate for each of the multiple lenders,
wherein the one or more processors are configured to predict the appropriate interest rate using the proposed interest rates predicted.
